(19) United States
(12) Patent Application Publication
(10) Pub. No.: US 2026/0130321 A1
(43) Pub. Date: May 14, 2026

(54) CHORE PRODUCT WITH INTEGRATED BRAKE AND LOCK PEDALS

(71) Applicant: Briggs & Stratton, LLC, Wauwatosa, WI (US)

(72) Inventor: Matthew Ricciardi, Milwaukee, WI (US)

(73) Assignee: Briggs & Stratton, LLC, Wauwatosa, WI (US)

(21) Appl. No.: 19/120,454

(22) PCT Filed: Oct. 16, 2023
(86) PCT No.: PCT/US2023/035200

§ 371 Date: Apr. 11, 2025

Related U.S. Application Data
(60) Provisional application No. 63/416,113, filed on Oct. 14, 2022.

(51) Int. Cl. A01D 69/10; A01D 34/66; A01D 34/82; A01D 101/00

(52) U.S. Cl. CPC A01D 69/10; A01D 34/66; A01D 34/82; A01D 2101/00

(57) ABSTRACT

A brake assembly includes a brake pedal pivotally coupled to a base plate at a first rotation point and including a first pedal portion, the brake pedal configured to pivot from a first disengaged configuration to a first engaged configuration. The brake assembly further includes a lock pedal including a second pedal portion, the lock pedal rotatably coupled to the brake pedal and configured to move from a second disengaged configuration to a second engaged configuration when force is applied to the second pedal portion, wherein the brake pedal is configured to pivot from the first disengaged configuration to the first engaged configuration when the force is applied to the second pedal portion. The lock pedal is configured to remain in the second engaged configuration and the brake pedal is configured to remain in the first engaged configuration when the force on the second pedal portion is removed.

### CROSS-REFERENCE TO RELATED PATENT APPLICATIONS

This application claims the benefit of and priority to U.S. Provisional Ser. No. 63/416,113 , filed on Oct. 14, 2022, the entire disclosure of which is hereby incorporated by reference herein.

### BACKGROUND

Outdoor power equipment or chore products can include a brake to slow down or stop the equipment/product during travel.

### SUMMARY

At least one embodiment relates to a brake assembly for a battery-powered chore product. The brake assembly includes a brake pedal pivotally coupled to a base plate at a first rotation point and including a first pedal portion. The brake pedal is configured to pivot from a first disengaged configuration to a first engaged configuration. The brake assembly also includes a lock pedal including a second pedal portion. The lock pedal is configured to move from a second disengaged configuration to a second engaged configuration when force is applied to the second pedal portion. The brake pedal is configured to pivot from the first disengaged configuration to the first engaged configuration when the force is applied to the second pedal portion. The lock pedal is configured to remain in the second engaged configuration and the brake pedal is configured to remain in the first engaged configuration when the force on the second pedal portion is removed.

Another embodiment relates to a battery-powered chore product including a chassis, a rear wheel coupled to the chassis, an electric drive motor coupled to the rear wheel by a transmission configured to deliver rotational energy from the electric drive motor to the rear wheel, a base plate coupled to the chassis, a brake pedal pivotally coupled to the base plate at a first rotation point and including a first pedal portion, the brake pedal configured to pivot from a first disengaged configuration to a first engaged configuration, and a lock pedal including a second pedal portion. The lock pedal is configured to move from a second disengaged configuration to a second engaged configuration when force is applied to the second pedal portion. The brake pedal is configured to pivot from the first disengaged configuration to the first engaged configuration when the force is applied to the second pedal portion. The lock pedal is configured to remain in the second engaged configuration and the brake pedal is configured to remain in the first engaged configuration when the force on the second pedal portion is removed.

Another embodiment relates to a brake assembly for a battery-powered chore product. The brake assembly includes a brake pedal pivotally coupled to a base plate by a first rotation pin and including a first pedal portion. The brake pedal is configured to pivot from a first disengaged configuration to a first engaged configuration. The brake assembly also includes a lock pedal pivotally coupled to the brake pedal by a second rotation pin and including a second pedal portion. The lock pedal is configured to move from a second disengaged configuration to a second engaged configuration when force is applied to the second pedal portion. The lock pedal is configured to move the brake pedal from the first disengaged configuration to the first engaged configuration via the second rotation pin when the force is applied to the second pedal portion. The lock pedal is configured to remain in the second engaged configuration and the brake pedal is configured to remain in the first engaged configuration when the force on the second pedal portion is removed.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a side perspective view of a zero-turn radius ride-on lawn mower, according to an exemplary embodiment;

FIG. 2A is a perspective view of a brake assembly of the zero-turn radius ride-on lawnmower of FIG. 1 in a disengaged configuration, according to an exemplary embodiment;

FIG. 2B is a perspective view of the brake assembly FIG. 2A in an engaged configuration;

FIG. 3A is a left side view of the brake assembly of FIG. 2A in the disengaged configuration;

FIG. 3B is a left side view of the brake assembly FIG. 2A in the engaged configuration;

FIG. 4 is a right side perspective view of the brake assembly FIG. 2A;

FIG. 5 is a right side view of a transmission assembly of the zero-turn radius ride-on lawnmower of FIG. 1, according to an exemplary embodiment;

FIG. 6A is a perspective view of a brake assembly of the zero-turn radius ride-on lawnmower of FIG. 1 in a disengaged configuration, according to an exemplary embodiment;

FIG. 6B is a perspective view of the brake assembly FIG. 6A in an engaged configuration; and

FIG. 7 is a schematic illustration of a controller of the zero-turn radius ride-on lawnmower of FIG. 1.

### DETAILED DESCRIPTION

Before turning to the figures, which illustrate the exemplary embodiments in detail, it should be understood that the present application is not limited to the details or methodology set forth in the description or illustrated in the Figures. It should also be understood that the terminology is for the purpose of description only and should not be regarded as limiting.

The present disclosure is directed to battery-powered outdoor power equipment or chore products. A “chore product” as used herein refers to any type of equipment, machine, or vehicle that may be used to perform a chore (e.g., an outdoor chore, an indoor chore, lawn care, etc.). For example, a chore product may include a motor, a pump, an actuator, a compressor, and/or another device that is electrically-powered to operate some function of the chore product to facilitate performing a chore. In some embodiments, a chore is a task performed, either by a user or autonomously, at or near a household, a farm, an agricultural facility, a building, a sidewalk, a park, a parking lot, a forest, a field, and/or a lawn. In some embodiments, a chore product transports an operator and performs a chore. In some embodiments, a chore product autonomously operates to perform a chore without an operator being present on the chore product or physically/manually manipulating the chore product.

The figures depict a zero-turn radius ride on lawn mower that includes a brake assembly with a brake pedal and a lock pedal configured to lock the brake pedal in an engaged position by depressing only the lock pedal or both the lock pedal and the brake pedal at the same time. The brake pedal may be released from the engaged and locked position by pressing down on the brake pedal while not pressing down on the lock pedal. It should be understood that although described in the context of a zero-turn radius mower, the brake assemblies described herein can be applicable to other chore products, including outdoor power equipment, indoor power equipment, light vehicles, aerial man lifts, floor care devices, golf carts, lift trucks and other industrial vehicles, recreational utility vehicles, industrial utility vehicles, and lawn and garden equipment. Outdoor power equipment may include lawn mowers, riding tractors, snow throwers, pressure washers, tillers, log splitters, walk-behind mowers, riding mowers, and turf equipment such as spreaders, sprayers, seeders, rakes, and blowers. Outdoor power equipment may, for example, use one or more electric motors to drive an implement, such as a rotary blade of a lawn mower, a pump of a pressure washer, the auger of a snow thrower, the alternator of a generator, and/or a drivetrain of the outdoor power equipment. Indoor power equipment may include floor sanders, floor buffers and polishers, vacuums, etc.

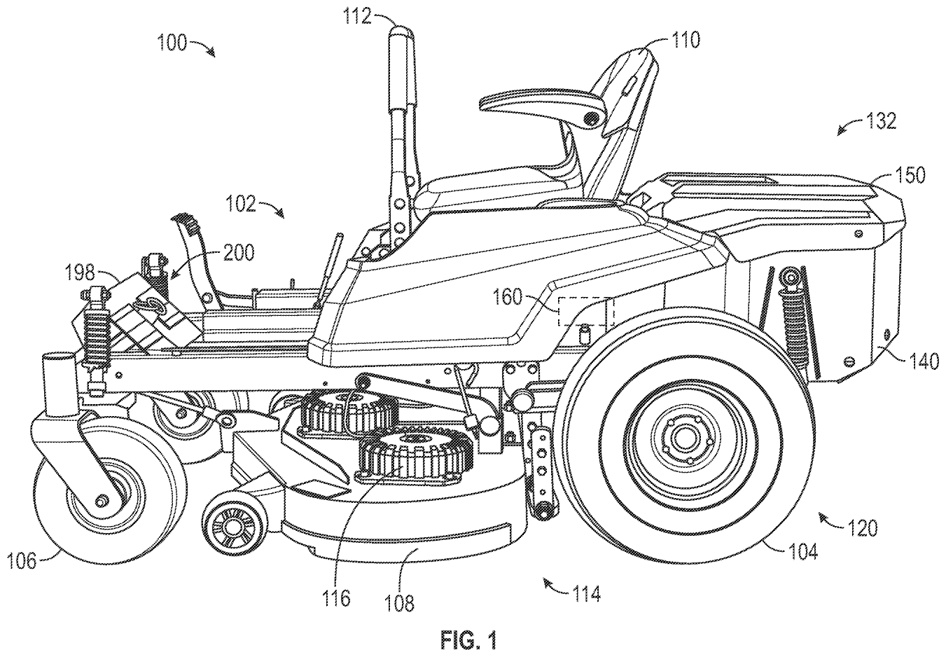

Referring now to FIG. 1, a chore product or piece of outdoor power equipment, shown as a zero-turn radius lawn mower 100, is illustrated (hereinafter “ZTR 100”). In an exemplary embodiment, the ZTR 100 includes a chassis 102 that supports rear wheels 104, front wheels 106, and/or a deck assembly 108. The chassis 102 may include a plurality of frame members arranged in parallel, which may extend along a longitudinal direction (e.g., a forward and a backward direction) between a front portion and a rear portion of the ZTR 100. The frame members of the chassis 102 may be laterally spaced to define a cavity and/or void therebetween, so as to provide an area for concealing and/or mounting other components of the ZTR 100 (e.g., a motor, drive train, battery packs, etc.). In some embodiments, the chassis 102 does not include a plurality of frame members; rather, the chassis 102 includes additional, fewer, and/or different working components.

As shown in FIG. 1, the rear wheels 104 are rotatably coupled to the chassis 102 at a rear portion of the chassis 102. According to an exemplary embodiment, the rear wheels 104 are coupled to the chassis 102 via independent axles, and are configured to be driven (e.g., via an actuator, electric motor, control system, etc.). In an exemplary embodiment, each of the rear wheels 104 is driven independently by a motor (e.g., an electric motor, brushless DC motor, AC motor, a traction motor, etc.). The front wheels 106 may be coupled to the chassis 102 at a front portion of the chassis 102 and/or other components of the ZTR 100, and may be configured to be steerable (e.g., via a steering assembly, handlebars, a control system, motors, etc.). According to an exemplary embodiment, the front wheels 106 are non-traction wheels (e.g., hub or castor wheels, etc.), and each of the front wheels 106 is steerable via a motor (e.g., an electric motor, brushless DC motor, AC motor, a hub motor, etc.). In some embodiments, the ZTR 100 includes additional wheels on additional components of the ZTR 100 (e.g., the deck assembly 108, a mowing assembly, etc.) It should be understood that while the ZTR 100 is shown to have four wheels (e.g., two rear wheels 104, two front wheels 106), the ZTR 100 may have any suitable wheel configurations, for example, single axle sets, dual axle sets, independent axles, with two, four, six, eight, and/or any other suitable number of wheels. In some embodiments, the ZTR 100 includes a transmission system (e.g., the transmission assembly 300) configured to deliver rotational energy from a motor to the wheels (e.g., the rear wheels 104 and/or the front wheels 106).

As shown in FIG. 1, the deck assembly 108 includes a seat 110, a steering assembly shown as handlebars 112, a mower deck shown as mowing assembly 114, and a drive assembly 120. According to an exemplary embodiment, the seat 110 is positioned towards the rear portion of the chassis 102 and extends above the deck assembly 108, and is configured to support a user and/or operator. The handlebars 112 may extend upwardly from the chassis 102 proximate to the seat 110 and may be manipulated to allow a user and/or operator to control the movement of the ZTR 100. In an exemplary embodiment, the handlebars 112 are configured to individually and independently control a plurality of motors that drive the rear wheels 104 (and/or the front wheels 106, etc.), which allows the ZTR 100 to perform precise and tight turning maneuvers. In some embodiments, one or more inputs (e.g., buttons, knobs, handles, levers, etc.) are also positioned proximate to the seat 110 and are configured to selectively activate and/or control components of the ZTR 100 (e.g., the motors of the mowing assembly 114, the motors of the drive assembly 120, etc.). In other embodiments, a series of pedals are positioned within a foot space below the seat 110 and are configured to receive physical commands from a user to power (e.g., drive) the ZTR 100.

The mowing assembly 114 may be coupled to a front portion of the chassis 102 (e.g., between the rear wheels 104 and the front wheels 106), and may be configured to modify (e.g., cut, etc.) a surface. According to an exemplary embodiment, the mowing assembly 114 includes a deck that surrounds one or more blades. Each of the blades may be driven (e.g., powered) via a motor 116 (e.g., an electric motor, brushless DC motor, AC motor, a hub motor, etc.). In some embodiments, the mowing assembly 114 includes additional, fewer, and/or different working components. For example, the mowing assembly 114 may include motors (e.g., for height adjustment, chute controls, etc.), hydraulics (e.g., for actuating the mowing assembly 114 between up/down, mowing/storage, etc.), additional attachments (e.g., chutes, spreaders, blowers, power rakes, vacuum baggers, etc.), sound reducing inserts (e.g., foam, rubber, gel, etc.), power and/or data connections, etc. In this regard, the additional, fewer, and/or different working components of the mowing assembly 114 may also be driven (e.g., powered) via the motor 116.

In an exemplary embodiment, components of the mowing assembly 114 (e.g., deck, etc.) are configured to hinge and/or actuate into different positions (e.g., up for storage, etc.), so as to reduce the footprint of the ZTR 100. In some embodiments, components of the mowing assembly 114 are configured to be installed and/or removed (e.g., via a slide on/off mechanism), so as to permit the ZTR 100 to drive onto/off the mowing assembly 114. The mowing assembly 114 and/or the ZTR 100 may include one or more latching devices, which allow for mating of the mowing assembly 114 and the ZTR 100. In other embodiments, the mowing assembly 114 is further configured to allow for blades to be front loaded onto the mowing assembly 114, so as to allow for blades to be installed/replaced without requiring a user to be below components of the mowing assembly 114 (e.g., the deck).

In an exemplary embodiment, the drive assembly 120 includes a motor 130 (not shown) and a battery assembly 132. According to an exemplary embodiment, the motor 130 is configured to drive (e.g., power, etc.) components of the ZTR 100, for example, the rear wheels 104 to propel the ZTR 100, etc. In an exemplary embodiment, the motor 130 is an electric motor, for example a DC motor (e.g., a brushless DC motor, a DC shunt motor, a separately excited motor, a series motor, a PMDC motor, a compound motor, etc.), an AC motor (e.g., an induction motor, synchronous motor, etc.), and/or any other suitable electric motor (e.g., a stepper motor, hysteresis motor, reluctance motor, universal motor, etc.). While described as only including one motor 130, it should be understood that the drive assembly 120 of ZTR 100 may include a plurality of motors 130 (e.g., traction actuator(s), hub or steering actuator(s), implement actuator(s), etc.). For example, the ZTR 100 may include a plurality of motors 130, with a motor 130 at each rear wheel 104, so as to independently and individually drive (e.g., power) the rear wheels 104. In other embodiments, the drive assembly 120 includes additional, fewer, and/or different working components, which are configured to couple to, and/or interact with, the motor 130 and/or the battery assembly 132. For example, the drive assembly 120 may include a drive shaft, differential(s), axle shaft(s), universal join(s), constant-velocity joint(s), etc.

In an exemplary embodiment, the battery assembly 132 includes one or more battery packs and is configured to power the motor(s) 130 and/or other components of the ZTR 100 (e.g., the steering assembly, the mowing assembly 114, a controller, etc.). As will be discussed in greater detail below, in an exemplary embodiment the battery assembly 132 includes a receptacle 140 housing a plurality of battery packs (not shown). As shown in FIG. 1, the battery assembly 132 is positioned at a rear portion of the chassis. In an exemplary embodiment, the battery assembly 132 is positioned and/or angled relative to the chassis 102, so as to balance the weight of the ZTR 100. For example, the battery assembly 132 may be configured to offset (e.g., counteract, counterbalance, etc.) the weight(s) of other component(s) of the ZTR 100 (e.g., the mowing assembly 114, the drive assembly 120, a mower deck, etc.), so as to better balance the overall weight of the ZTR 100. In other embodiments, the battery assembly 132 is positioned at other portions of the chassis 102 (e.g., the front portion, a middle portion, etc.), and/or is angled relative to another plane (e.g., a vertical plane, an angled plane, etc.) when the ZTR 100 is in an operating position.

As shown in FIG. 1, the receptacle 140 also includes a cover 150. According to an exemplary embodiment, the cover 150 is rotatably coupled to a rear portion of the ZTR 100 and is configured to selectively enclose components of the ZTR 100 (e.g., the battery assembly 132, the battery packs 142, the motor 130, etc.). In an exemplary embodiment, the cover 150 is rotatable between an open position and a closed position. In this regard, when the cover 150 is in an open position, components of the ZTR 100 (e.g., the battery assembly 132, the battery packs 142, the motor 130, etc.) may be partially exposed to the outside environment (e.g., accessible to a user, etc.). Conversely, when the cover 150 is in a closed position, components of the ZTR 100 may be enclosed (e.g., housed, etc.) and/or protected from the outside environment.

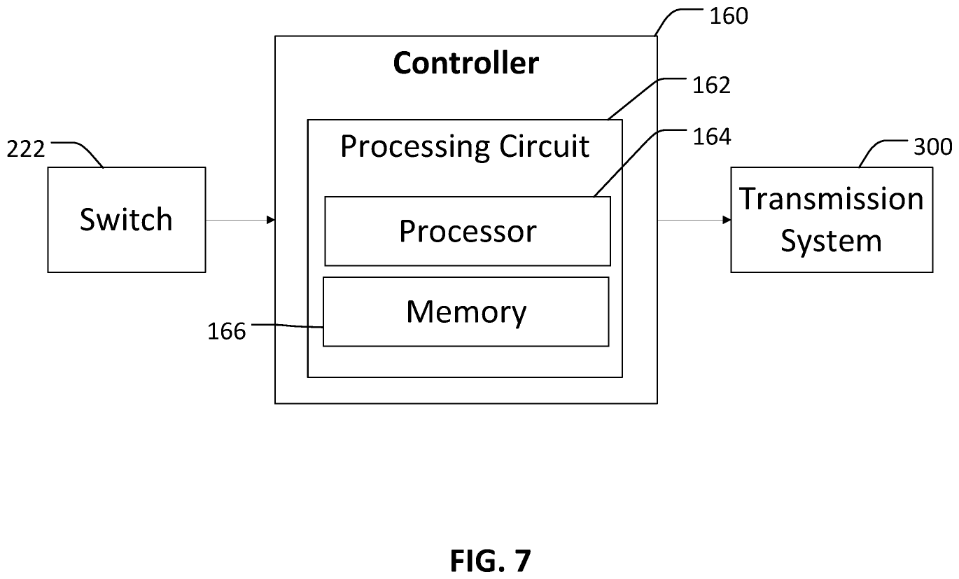

As shown in FIGS. 1 and 7, the ZTR 100 also includes a controller 160, which is coupled to the motor 130, the battery assembly 132, and/or other components of the ZTR 100 (e.g., the steering assembly, the mowing assembly 114, motors of the ZTR 100, etc.). In an exemplary embodiment, the controller 160 includes a processing circuit 162 having a processor 164 and a memory 166, and is configured to provide control over components of the ZTR 100 (e.g., the handlebars 112, motor 116 of the mowing assembly 114, motor(s) 130, the drive assembly 120, etc.). The processor 164 may be general purpose or specific purpose processor, an application specific integrated circuit (ASIC), one or more field programmable gate arrays (FPGAs), a group of processing components (e.g. parallel processing units), a neural network processing system, and/or any other suitable processor. In an exemplary embodiment, the processor 164 is configured to execute computer code or instructions stored in the memory 166, and/or received from other computer readable media, such as physical media (e.g. CD-ROM, DVD-Rom, flash drive, etc.), network drives, remote servers, mobile devices, etc. The memory 166 may include one or more devices (e.g. memory units, memory devices, storage devices, etc.) for storing data and/or computer code for completing and/or facilitating the functions and processes described herein. Further, the memory 166 may include random access memory (RAM), read-only memory (ROM) hard drive storage (physical or solid state), temporary storage, non-volatile memory, flash memory, optical memory, or any other suitable memory component for storing software objects and/or computer instructions. In an exemplary embodiment, the memory 166 is communicably connected to the processor 164 via the processing circuit 162, and includes computer code for executing (e.g. by the processor 164) one or more processes described herein.

In an exemplary embodiment, the processing circuit 162 also includes one or more circuits for controlling and/or implementing functions of the ZTR 100. For example, the controller 160 may include an implement control circuit (e.g., to control characteristics of implements of the mowing assembly 114, for example, motors 116, blades, blowers, chutes, etc.), a drive control circuit (e.g., to control characteristics of components of the drive assembly 120, for example, the motor(s) 130, drive shaft, differentials, etc.), an operational control circuit (e.g., to control components of the steering assembly, for example, the handlebars 112, an interface, the controller 160, etc.), a power systems circuit (e.g., to control components of a power system, for example, the battery assembly 132, a battery pack 142, the controller 160, etc.), and/or any other circuit suitable to control and/or implement the functions of the ZTR 100. Further, the controller 160 may include a communications interface, which may be configured to send/receive information (e.g., data, etc.) to/from other components of the ZTR 100 and/or external devices (e.g., a user device, a user application, a network, a server, etc.). In some embodiments, the controller 160 includes additional, fewer, and/or different working components. For example, the controller 160 may include any number of input/output (I/O) connections (e.g., I/O connections of the motor(s) 130, the battery assembly 132, etc.), communication buses (e.g., for the mowing assembly 114, the drive assembly 120, etc.), etc., which may be connected to one or more components of the ZTR 100 (e.g., the battery assembly 132, the motor(s) 130, etc.) in order to send/receive information (e.g., data) relating to components of the ZTR 100.

In other embodiments, the ZTR 100 includes additional, fewer, and/or different working components. For example, the ZTR 100 may also include an ignition interface (e.g., touchscreen, switch, etc.) to start/stop the ZTR 100, a sensor (e.g., motion, moisture, magnetic, temperature, chemical, etc.) to provide visual, audio, tactile, etc. feedback, an antenna to communicate with one or more devices (e.g., the controller 160, a mobile device, location device, etc.), counterweights to counteract forces (e.g., weight, etc.) supplied by components of the ZTR 100 (e.g., the battery assembly 132, the battery packs 142, etc.), and/or any other suitable component. In some embodiments, the ZTR 100 may include a brake assembly 200 positioned proximate a footrest 198 of the ZTR 100. The brake assembly 200 is shown and described in further detail below.

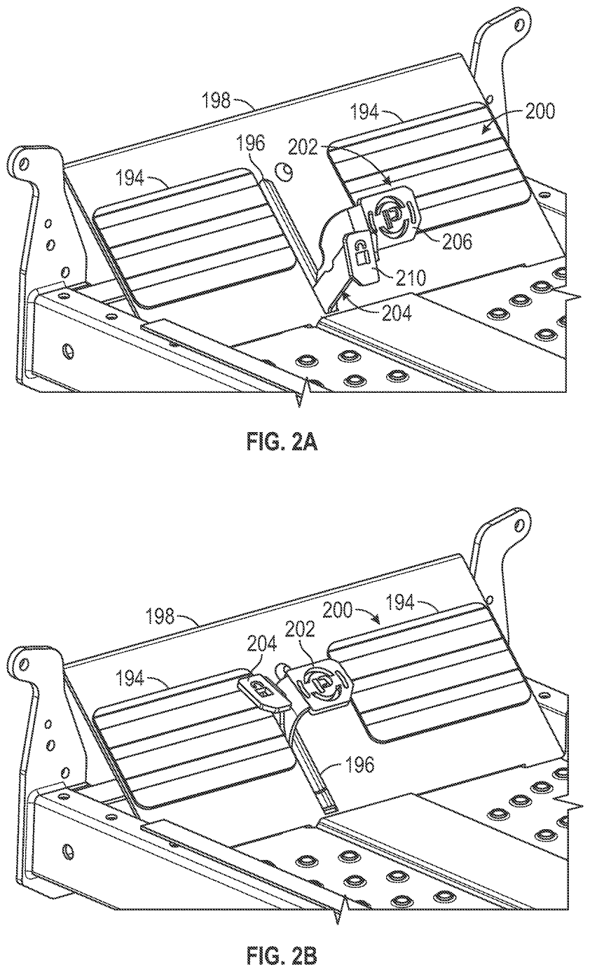

Referring now to FIGS. 2A and 2B, the brake assembly 200 is shown in a disengaged configuration and an engaged configuration, respectively, according to some embodiments. The brake assembly 200 includes a brake pedal 202 and a lock pedal 204. The brake pedal 202 includes a pedal portion 206 coupled to a distal end of an arm portion 208. The pedal portion 206 may be substantially parallel to the footrest 198 such that a user of the ZTR 100 can step on the pedal portion 206 to engage the brake pedal 202. The arm portion 208 extends through a slot 196 in the footrest 198 and is pivotally coupled at its proximal end to additional components of the brake assembly 200. The footrest 198 may further one or more pads 194 to further support and provide friction under a user's feet when operating the ZTR 100. To move the brake pedal 202 from the disengaged position (shown in FIG. 2A) to the engaged position (shown in FIG. 2B), a user may step on the pedal portion 206 and push it towards the footrest 198. The brake pedal 202 may pivot about the proximal end of the arm portion 208, causing the arm portion 208 to move from the bottom of the slot 196 to the top of the slot 196. In some embodiments, engaging the brake pedal 202 may cause a brake on the transmission system (e.g., the transmission assembly 300) to stop or reduce the transmission of power to the drive wheels (e.g., the wheels 104, etc.) in order to reduce the rotational speed or stop the rotation of the drive wheels. For example, in some embodiments, moving the brake pedal 202 to the engaged configuration may apply a braking force to stop or reduce the rotation of components in the transmission assembly 300 and/or may move the transmission assembly 300 to a “neutral” position in which the transmission components continue to rotate but are disengaged from the drive wheels. In some embodiments engaging the brake pedal 202 may cause a friction brake (e.g., a disc brake, a rim brake, etc.) to engage one or more of the wheels (e.g., the wheels 106, the wheels 104) to prevent or restrict the wheels from rotating.

The lock pedal 204 is configured similarly to the brake pedal 202. The lock pedal includes a pedal portion 210 coupled to a first end of an arm portion 212. The pedal portion 210 may be substantially parallel to the footrest 198 such that a user of the ZTR 100 can step on the pedal portion 210 to engage the lock pedal 204. The arm portion 212 extends through the slot 196 and is pivotally coupled to the arm portion 208 of the brake pedal 202. To move the lock pedal 204 from the disengaged position (shown in FIG. 2A) to the engaged position (shown in FIG. 2B), a user may step on the pedal portion 210 and push it towards the footrest 198. The lock pedal 204 may pivot about the proximal end of the arm portion 212, causing the arm portion 212 to move from the bottom of the slot 196 to the top of the slot 196.

When the lock pedal 204 is depressed, the lock pedal 204 may cause the brake pedal 202 to be depressed as well. Depressing the lock pedal 204 may therefore have the same effect as simultaneously depressing the lock pedal and 204 and the brake pedal 202. Both the brake pedal 202 and the lock pedal 204 may be biased toward the disengaged position, for example, by a spring and/or lever. When the lock pedal 204 is depressed fully to the engaged configuration, as shown in FIG. 2B, the brake pedal 202 and lock pedal 204 may remain locked in the engaged configuration until disengaged. If the brake pedal 202 alone is depressed, either partially or fully, it may return to the disengaged position when the pressure (e.g., from a user's foot) is removed. If the lock pedal 204 and brake pedal 202 are only partially (e.g., not fully) depressed, the lock pedal 204 and brake pedal 202 may return to the disengaged position when the pressure (e.g., from a user's foot) is removed. Thus, the lock pedal 204 may only lock the brake pedal 202 in the engaged position when the lock pedal 204 is fully depressed to the engaged position. The brake pedal 202 and lock pedal 204 may also both be locked in the engaged position when the brake pedal 202 is depressed and the lock pedal 204 is subsequently depressed. For example, a user may depress the brake pedal 202 with a first foot, stopping the ZTR 100 and holding the ZTR 100 in position, and then depressing the lock pedal to lock the brake pedal 202 and lock pedal 204 in the engaged position. When the brake pedal 202 and the lock pedal 204 are locked in the engaged position, the brake pedal 202 can be depressed and then released to disengage the lock and the brake, and the brake pedal 202 and lock pedal 204 can return to the disengaged position.

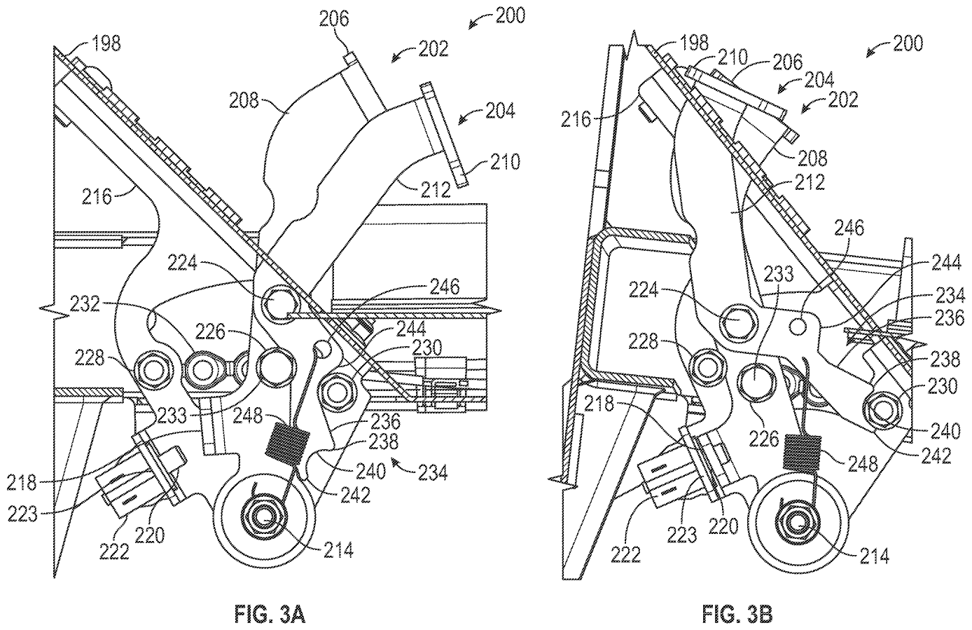

Referring now to FIGS. 3A and 3B, side views of the brake assembly 200 are shown in the disengaged configuration and the engaged configuration, respectively, according to some embodiments. The proximal end of the arm portion 208 of the brake pedal 202 is pivotally coupled via a first rotation pin 214 to a base plate 216, which is coupled to the footrest 198 of the ZTR 100. The brake pedal 202 may pivot about the longitudinal axis of the first rotation pin 214 (e.g., a bolt, a screw, a shoulder bolt) to move between the disengaged configuration and the engaged configuration. The arm portion 208 of the brake pedal 202 is pivotally coupled to the arm portion 212 of the lock pedal 204 via a second rotation pin 224 (e.g., a bolt, a screw, a shoulder bolt). The brake pedal 202 may further include a flange 218 configured to depress a plunger 220 of an electrical switch 222 coupled to a flange 223 of the base plate 216 when the brake pedal 202 is in the engaged configuration. The flange 218, as well as the pedal portion 206 of the brake pedal 202, may be formed by bending or brake forming, such that the entire brake pedal may be formed from a single plate of material. The electrical switch 222 may be a normally-open switch and may be communicably coupled to the controller 160 (see, e.g., FIG. 7). In some embodiments, the electrical switch 222 may be used in the startup and shutdown procedure of the ZTR 100. For example, the controller 160 may require a signal from the switch 222 indicating that the plunger 220 is depressed (by the brake pedal 202) in order to enable motors of the ZTR 100 (e.g., to enable the motors of the mowing assembly 114 and/or the motors of the drive assembly 120, etc.), so that the ZTR 100 may not begin rolling unexpectedly upon startup. Similarly, the controller 160 may require a signal from the switch 222 indicating that the plunger 220 is depressed in order to shut down the ZTR 100. In some embodiments, if the controller 160 detects a signal that the plunger 220 is depressed while the ZTR 100 is moving, the controller 160 can stop the transmission system 300 of the ZTR 100 so that no power is delivered to the drive wheels (e.g., the wheels 104, etc.) when the user wants to stop the movement of the ZTR 100.

In some embodiments, the brake assembly 200 further includes a first bearing 226 (e.g. a sleeve bearing, a cam follower, a roller, a spacer etc.) coupled to the arm portion 208 to the brake pedal 202 that extends into the path of rotation of the arm portion 212 of the lock pedal 204. The rotation of the lock pedal 204 relative to the brake pedal 202 may be restricted in the clockwise direction (as shown in FIGS. 3A and 3B) because the arm portion 212 of the lock pedal 204 contacts the first bearing 226 (as shown in FIG. 3A). The brake assembly 200 may include a second bearing 228 (e.g. a sleeve bearing, a cam follower, a roller, a spacer etc.) coupled to the base plate 216 that extends into the path of rotation of the arm portion 208 of the brake pedal 202. It should be understood that, in some embodiments, the bearings 226, 228 may be spacers that are held in place by tightened fasteners and are unable to rotate. The rotation of the brake pedal 202 about the first rotation pin 214 may be restricted in the counterclockwise direction (as shown in FIGS. 3A and 3B) because the arm portion 208 of the brake pedal 204 contacts the second bearing 228 (as shown in FIG. 3B). The brake assembly 200 may include a third bearing 230 (e.g. a sleeve bearing, a cam follower, a roller, etc.) coupled to the base plate 216 that extends into the path of rotation of the arm portion 208 of the brake pedal 202, as well as the arm portion 212 of the lock pedal 204. The rotation of the brake pedal 202 about the first rotation pin 214, as well as the rotation of the lock pedal 204 relative to the brake pedal 202, may be restricted in the clockwise direction (as shown in FIGS. 3A and 3B) because the arm portion 212 of the brake pedal 202 and the arm portion 212 of the lock pedal 204 contact the third bearing 230 (as shown in FIG. 3A). One or more brake cables 232 under tension may be coupled to a fastener 233 coupled to the arm portion 208 of the brake pedal 202. In some embodiments, the fastener 233 may also couple the first bearing 226 to the arm portion 208 of the brake pedal 202. The brake cables 232 may be spring-loaded to bias the brake pedal 202 towards the disengaged configuration. Thus, when the lock pedal 204 is disengaged, the brake cables 232 may pull the brake pedal 202 in the clockwise direction (as shown in FIGS. 3A and 3B) back to the disengaged position whenever insufficient force is applied to the pedal portion 206 by a user.

In some embodiments, the arm portion 212 of the lock pedal 204 includes a cam profile 234. The cam profile 234 may include a lever portion 236, a high point 238, and a catch 240 with a hook 242. In order to lock the brake assembly 200 in the engaged position, a user may press down on the pedal portion 210 of the lock pedal 204. As the user presses down, the lock pedal 204 pivots about the second rotation pin 224. With the lever portion 236 of the cam profile 234 in contact with the third bearing 230, the arm portion 212 of the lock arm acts as a lever to push the brake pedal 202, via the second rotation pin 224, in the counterclockwise direction (as shown in FIGS. 3A and 3B). As the lock pedal 204 is further depressed, the lock pedal 204 continues to rotate about the second rotation pin 224 while the brake pedal 202 and lock pedal 204 also rotate about the first rotation pin 214, and the contact point between the third bearing 230 and the cam profile 234 moves towards the high point 238. The third bearing 230 may be configured to rotate about its axis in order to reduce the friction between the third bearing 230 and the cam profile 234. As the user continues to depress the lock pedal 204 and the contact point between the third bearing 230 and the cam profile 234 passes the high point 238, the third bearing 230 goes “over-center” and enters the catch 240. If the user continues to depress the pedals 202, 204, shortly after the third bearing 230 enters the catch 240, the arm portion 208 of the brake pedal 202 may contact the second bearing 228, stopping further rotation of the brake pedal 202 in the counterclockwise direction (as shown in FIGS. 3A and 3B). It should be understood that, when the brake pedal 202 is in the engaged position but no force is being applied to the pedal portions 206, 210 of the brake pedal 202 or lock pedal 204, the arm portion 208 of the brake pedal does not contact the second bearing 228. As will be explained below, a user may depress the pedal portion 206 of the brake pedal 202 slightly farther to disengage the catch 240 of the lock pedal 204. The bearing 228 therefore is intended to stop the brake pedal 202 from rotating farther than is necessary to disengage the catch 240. The hook 242 contacts the third bearing to stop the lock pedal 204 from rotating further in the counterclockwise direction (as shown in FIGS. 3A and 3B). Once the third bearing 230 is in the catch 240 and the pressure is released from the pedal portion 210 of the lock pedal 204, the high point 238 stops the lock pedal from rotating in the clockwise direction (as shown in FIGS. 3A and 3B) back to the disengaged position. Thus, the lock pedal 204 and the brake pedal 204 (due to the connection to the lock pedal 204 at the second rotation pin 224) are retained in the engaged configuration. In some embodiments, the cam profile 234 includes an upper portion 244 that can restrict the rotation of the lock pedal 204 in the clockwise direction (as shown in FIGS. 3A and 3B). Thus, the first bearing 226, which performs a similar function, may not be necessary. There may be clearance between the arm portion 212 of the lock pedal 204 and the fastener 233 when the cam profile 234 is in contact with the third bearing 230.

The arm portion 212 of the lock pedal 204 may include a hook point 246 (e.g., a hole, an opening, a pin, a fastener, etc.) to which a spring 248 is coupled. The spring 248 may be coupled at its opposite end to the first rotation pin 214 or to a fastener or component near the first rotation pin 214. The spring 248 may be a tension spring configured to bias the lock pedal 204 in the clockwise direction (as shown in FIGS. 3A and 3B). To release the brake pedal 202 and lock pedal 204 from the locked, engaged configuration, a user may depress the pedal portion 206 of the brake pedal 202 without depressing the pedal portion 210 of the lock pedal 204. With no force from the user applied to the lock pedal 204, the spring 248 pulls the lock pedal 204 in the clockwise direction (as shown in FIGS. 3A and 3B), moving the contact point between the third bearing 230 and the cam profile 234 back towards the high point 238. As the user continues to depress the brake pedal 202 and the contact point between the third bearing 230 and the cam profile 234 passes the high point 238, the third bearing 230 goes “over-center” and exits the catch 240. Once the third bearing 230 goes “over-center” and exits the catch 240, the spring 248 may continue to pull the lock pedal 204 in the clockwise direction (as shown in FIGS. 3A and 3B) so that the third bearing 230 cannot reenter the catch 240. The second bearing 228 may stop the user from depressing the brake pedal 202 farther than necessary to release the third bearing 230 from the catch 240. Next, the user can release (e.g., stop applying force to) the brake pedal 202, causing the brake pedal 202 to pivot in the clockwise direction (as shown in FIGS. 3A and 3B) due to the tension on the brake pedal 202 from the brake cables 232. The lock pedal 204 is pulled in the same direction, due to the connection to the brake pedal 202 via the second rotation pin 224, until the lever portion 236 of the cam profile 234 makes contact with the third bearing 230, causing additional clockwise rotation (as shown in FIGS. 3A and 3B) of the lock pedal 204.

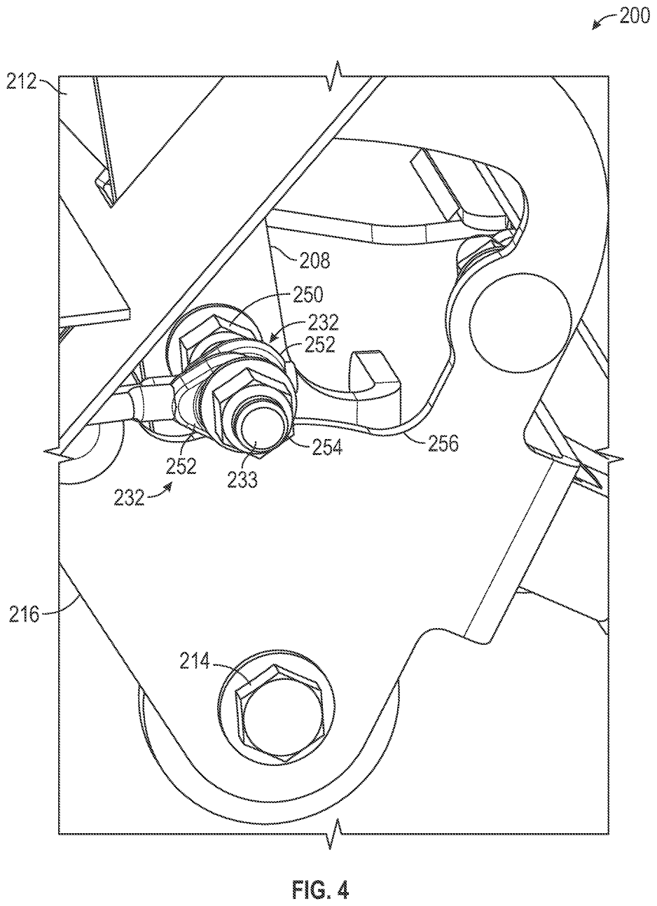

FIG. 4 shows a portion of the brake assembly 200 from the opposite side of the side shown in FIGS. 3A and 3B, according to some embodiments. A fastener 233 (e.g., a threaded rod, a rod, a post, etc.) extends from the arm portion 208 of the brake pedal 202. A first nut 250 is coupled to the fastener 233 to secure the fastener 233 to the arm portion 208 of the brake pedal 202. The brake cables 232 include loops 252 that can be hooked onto the fastener 233. A second nut 254 is then coupled to the fastener 233 to retain the brake cables 232. An additional locknut may be used to stop the second nut 254 from unthreading from the fastener 233. The base plate 216 includes a pocket 256 to allow for the movement of the fastener 233 when the brake pedal 202 is moved between the engaged and disengaged configurations.

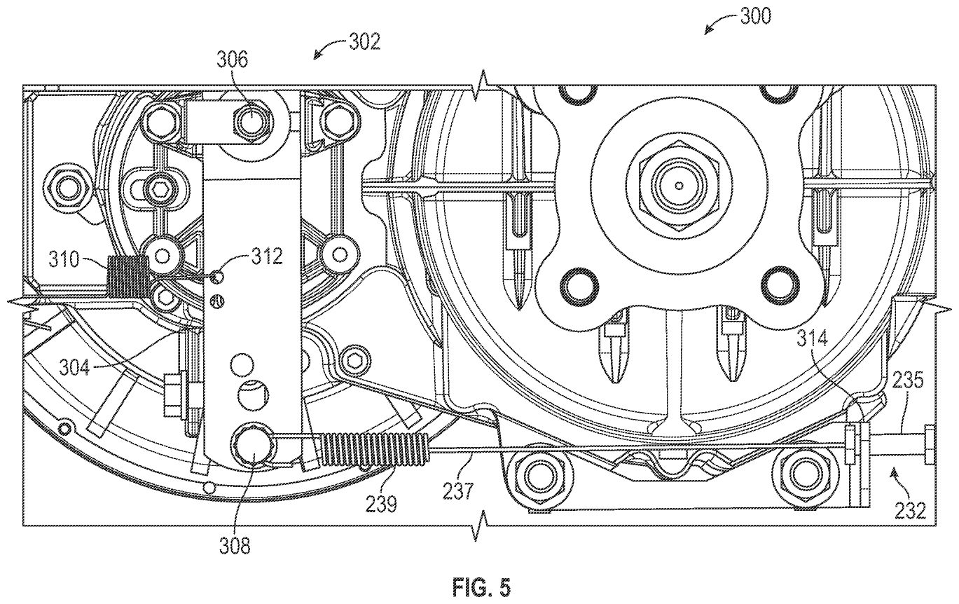

FIG. 5 shows a transmission assembly 300 of the ZTR 100, according to some embodiments. The transmission may transmit rotational energy from an electric drive motor to the drive wheels (e.g., the wheels 104 and/or the wheels 106) to turn the drive wheels and propel the ZTR 100. The transmission assembly 300 includes a transmission brake system 302 configured to apply a braking force to the transmission when the brake arm 304 is rotated about the rotation point 306. In some embodiments, the transmission brake system 302 may be considered part of the brake assembly 200. The brake cable 232 is coupled to a hook point 308 (e.g., a hole, an opening, a pin, a fastener, etc.) on the brake arm 304. When the brake pedal 202 is engaged, the fastener 233 pulls the brake cable 232, which then pulls the hook point 308 and rotates the brake arm 304 to apply the braking force to the transmission. A first brake cable 232 may be coupled to a first brake arm 304 on the right side of the transmission assembly 300 (e.g., on the right side of the ZTR 100) and a second brake cable 232 may be coupled to a second brake arm 304 on the left side of the transmission assembly 300 (e.g., on the left side of the ZTR 100). The transmission assembly 300 may include a return spring 310 coupled to a second hook point 312 on the brake arm 304. The return spring 310 may apply a force in the opposite direction of the brake cable 232, such that the brake arm 304 returns to a disengaged position when the brake pedal 202 is released. For example, the return spring 310 may pull the brake arm 304 in a clockwise direction (as shown in FIG. 5), which pulls the brake cable 232 to the left, causing the brake pedal 202 to be pulled into the disengaged configuration. The brake cable 232 may be a Bowden cable, with a hollow outer casing 235 that is coupled to a mounting flange 314 and remains stationary and an inner cable 237 that is pulled within the casing 235 by the brake pedal 202 and the brake arm 304. The inner cable 237 may be coupled to the brake arm 304 by a spring 239, which may reduce any looseness in the brake cable 232 and improve the tactile feeling of depressing the brake pedal 202. The spring 239 further ensures that adequate force is applied to the brake lever 302 such that the ZTR 100 is stopped or held in position. The brake cable 232 and the electrical switch 222 thus may be configured to redundantly stop the transmission assembly 300 from transmitting power to the drive wheels to stop the movement of the ZTR 100.

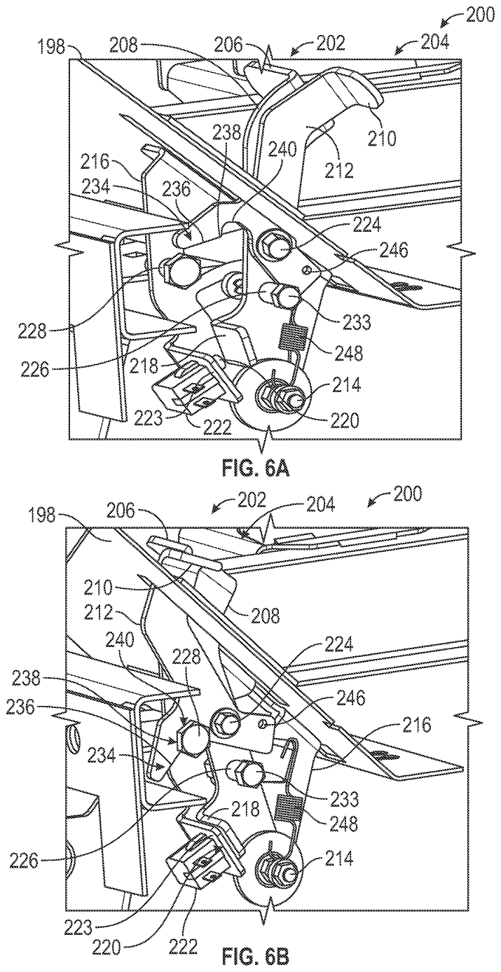

Referring now to FIGS. 6A and 6B, a brake assembly 200 is shown in a disengaged configuration and an engaged configuration, respectively, according to some embodiments. The brake assembly 200 shown in FIGS. 6A and 6B is substantially similar to the brake assembly 200 shown in FIGS. 2A and 2B. The brake pedal 202 is pivotally coupled to the base plate 216 by the first rotation pin 214, and the lock pedal 204 is pivotally coupled to the brake pedal 202 by the second rotation pin 224. Unlike the brake assembly 200 shown in FIGS. 2A and 2B, the brake assembly 200 shown in FIGS. 6A and 6B does not include a third bearing 230. Instead, the cam profile 234 is positioned on an extended member 231 on the left side (as shown in FIGS. 6A and 6B) of the arm portion 212 of the lock pedal 204. The second bearing 228 in the embodiment shown in FIGS. 6A and 6B performs the same functions as both the second bearing 228 and the third bearing 230 in the embodiment shown in FIGS. 2A and 2B. In particular, in the embodiment shown in FIGS. 6A and 6B, the second bearing 228 is configured to both stop the counterclockwise rotation (as shown in FIGS. 6A and 6B) of the brake pedal 202 and to engage the cam profile 234 to lock the lock pedal 204 in the engaged configuration. As discussed above with respect to FIGS. 2A and 2B, when the brake pedal 202 is in the engaged position but no force is being applied to the pedal portions 206, 210 of the brake pedal 202 or lock pedal 204, there is at least a small amount of clearance between the arm portion 208 of the brake pedal and the bearing 228. A user may depress the pedal portion 206 of the brake pedal 202 slightly farther beyond the engaged configuration to release the bearing 228 from the catch 240. When a user steps on and depresses the pedal portion 210 of the lock pedal 204, the lock pedal 204 rotates about the second rotation pin 224 until the lever portion 236 of the cam profile 234 contacts the second bearing 228. As the user continues to depress the pedal portion 210 of the lock pedal 204, the lock pedal 204 and the brake pedal 202 both rotate about the first rotation pin 214, due to the connection between the lock pedal 204 and the brake pedal 202 at the second rotation pin 224, and the contact point between the second bearing 228 and the lever portion 236 of the cam profile 234 moves towards the high point 238. Once the second bearing 228 crosses over the high point 238, the second bearing 228 goes “over-center” and enters the catch 240. When the user takes the pressure off of the pedal portion 210 of the lock pedal 204, the second bearing 228 is retained within the catch 240 by the high point 238, and the lock pedal 204 and the brake pedal 202 remain in the engaged position.

To release the brake pedal 202 and lock pedal 204 from the locked, engaged configuration, a user may depress the pedal portion 206 of the brake pedal 202 without depressing the pedal portion 210 of the lock pedal 204. With no force from the user applied to the lock pedal 204, the spring 248 pulls the lock pedal 204 in the clockwise direction (as shown in FIGS. 6A and 6B), moving the contact point between the second bearing 228 and the cam profile 234 back towards the high point 238. In some embodiments, the second bearing 228 may lose contact with the cam profile 234 entirely. As the user continues to depress the brake pedal 202 and the contact point between the second bearing 228 and the cam profile 234 passes the high point 238, the second bearing 228 goes “over-center” and exits the catch 240. Once the second bearing 228 exits the catch 240, the spring 248 may continue to pull the lock pedal 204 in the clockwise direction (as shown in FIGS. 6A and 6B) so that the second bearing 228 cannot reenter the catch 240. The lock pedal may rotate until the arm portion 212 of the lock pedal 204 makes contact with the first bearing 226. Then, the user can release (e.g., stop applying force to) the brake pedal 202, causing the brake pedal 202 to pivot in the clockwise direction (as shown in FIGS. 6A and 6B) due to the tension from the brake cables 232 on the fastener 233 coupled to the brake pedal 202. The lock pedal 204 is pulled in the same direction, due to the connection to the brake pedal 202 via the second rotation pin 224 and the contact with the first bearing 226. In the disengaged configuration, the lock pedal 204 is held in place by the second rotation pin 224 and the spring 248, which holds the arm portion 212 of the lock pedal 204 against the first bearing 226. The brake cable 232 may be coupled to the brake arm 304 as shown and described above with reference to FIG. 5.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the brake assembly 200 and the chore product 100 as shown in the various exemplary embodiments is illustrative only. Although only one example of an element from one embodiment that can be incorporated or utilized in another embodiment has been described above, it should be appreciated that other elements of the various embodiments may be incorporated or utilized with any of the other embodiments disclosed herein.

1. A brake assembly comprising:
a brake pedal pivotally coupled to a base plate at a first rotation point and comprising a first pedal portion, the brake pedal configured to pivot from a first disengaged configuration to a first engaged configuration; and
a lock pedal comprising a second pedal portion, the lock pedal configured to move from a second disengaged configuration to a second engaged configuration when force is applied to the second pedal portion, wherein the brake pedal is configured to pivot from the first disengaged configuration to the first engaged configuration when the force is applied to the second pedal portion;
wherein the lock pedal is configured to remain in the second engaged configuration and the brake pedal is configured to remain in the first engaged configuration when the force on the second pedal portion is removed.

2. The brake assembly of claim 1, wherein when a second force is applied to the first pedal portion and then released, the brake pedal is configured to be released from the first engaged configuration, and the lock pedal is configured to be released from the second engaged configuration.

3. The brake assembly of claim 1, further comprising a brake cable coupled to the brake pedal and configured to bias the brake pedal towards the first disengaged configuration, wherein the brake cable is coupled to a transmission brake arm of an electric motor, wherein movement of the brake pedal from the first disengaged configuration to the first engaged configuration is configured to cause the brake cable to rotate the transmission brake arm to apply a braking force to a transmission of the electric motor.

4. (canceled)

5. The brake assembly of claim 1, wherein the brake pedal is rotatably coupled to the lock pedal at a second rotation point, wherein the lock pedal comprises a cam profile that contacts a bearing coupled to the base plate, the cam profile configured to contact the bearing when the force is applied to the second pedal portion.

6. (canceled)

7. The brake assembly of claim 5, wherein as the lock pedal moves from the second disengaged configuration to the second engaged configuration, a contact point between the bearing and the cam profile moves along a lever portion to a high point, wherein when the contact point crosses the high point, the bearing enters a catch of the lock pedal and retains the lock pedal in the second engaged configuration.

8. The brake assembly of claim 7, further comprising a spring configured to bias the lock pedal towards the second disengaged configuration.

9. The brake assembly of claim 8, wherein when a second force is applied to the brake pedal in the first engaged configuration, the spring is configured to rotate the lock pedal to release the bearing from the catch.

10. The brake assembly of claim 9, wherein when the second force applied to the brake pedal in the first engaged configuration is released, the brake pedal is configured to return to the first disengaged configuration, and the lock pedal is configured to return to the second disengaged configuration.

11. The brake assembly of claim 1, further comprising an electrical switch comprising a plunger, the electrical switch configured to transmit a signal when the plunger is depressed, wherein the brake pedal is configured to depress the plunger when the brake pedal is in the first engaged configuration.

12. A chore product comprising:
a chassis;
a rear wheel coupled to the chassis;
an drive motor coupled to the rear wheel by a transmission configured to deliver rotational energy from the drive motor to the rear wheel;
a base plate coupled to the chassis;
a brake pedal pivotally coupled to the base plate at a first rotation point and comprising a first pedal portion, the brake pedal configured to pivot from a first disengaged configuration to a first engaged configuration; and
a lock pedal comprising a second pedal portion, the lock pedal configured to move from a second disengaged configuration to a second engaged configuration when force is applied to the second pedal portion, wherein the brake pedal is configured to pivot from the first disengaged configuration to the first engaged configuration when the force is applied to the second pedal portion;
wherein the lock pedal is configured to remain in the second engaged configuration and the brake pedal is configured to remain in the first engaged configuration when the force on the second pedal portion is removed.

13. (canceled)

14. The chore product of claim 12, further comprising a brake cable coupled at a first end to the brake pedal and at a second end to a transmission brake arm configured to apply a braking force to the transmission when the brake pedal is in the first engaged configuration, wherein the brake cable is a Bowden cable comprising a housing and an inner wire, the inner wire configured to move within the housing in response to movement of the brake cable, wherein a first spring couples the inner wire to the transmission brake arm.

15-16. (canceled)

17. The chore product of claim 14, further comprising a second spring configured to bias the transmission brake arm towards a position in which the braking force is not applied.

18. The chore product of claim 12, wherein the base plate is coupled to a footrest of the chassis, the brake pedal and the lock pedal extending through a slot in the footrest.

19. The chore product of claim 12, further comprising:
an electrical switch comprising a plunger, the electrical switch configured to transmit a signal when the plunger is depressed, wherein the brake pedal is configured to depress the plunger when the brake pedal is in the first engaged configuration; and
a controller comprising a memory and a processor, the memory storing instructions that, when executed by the processor, cause the processor to:
receive the signal from the electrical switch; and
in response to receiving the signal, stop the transmission from transmitting the rotational energy to the rear wheel.

20. The chore product of claim 19, wherein the instructions further cause the processor to:
receive a second signal to activate the drive motor;
determine whether the signal from the electrical switch is still being received; and
in response to determining that the signal from the electrical switch is still being received when the second signal to activate the drive motor is received, enable operation of the drive motor.

21. A brake assembly comprising:
a brake pedal pivotally coupled to a base plate by a first rotation pin and comprising a first pedal portion, the brake pedal configured to pivot from a first disengaged configuration to a first engaged configuration; and
a lock pedal pivotally coupled to the brake pedal by a second rotation pin and comprising a second pedal portion, the lock pedal configured to move from a second disengaged configuration to a second engaged configuration when force is applied to the second pedal portion, wherein the lock pedal is configured to move the brake pedal from the first disengaged configuration to the first engaged configuration via the second rotation pin when the force is applied to the second pedal portion;
wherein the lock pedal is configured to remain in the second engaged configuration and the brake pedal is configured to remain in the first engaged configuration when the force on the second pedal portion is removed.

22. The brake assembly of claim 21, wherein the lock pedal includes a lever portion configured to contact a first bearing to limit the rotation of the lock pedal relative to the brake pedal when the force is applied, wherein the lock pedal includes a catch configured to receive the first bearing to maintain the lock pedal in the second engaged configuration when a contact point between the lever portion and the first bearing crosses a high point as the force is applied to the lock pedal.

23. (canceled)

24. The brake assembly of claim 22, further comprising a spring configured to bias the lock pedal towards the second disengaged configuration, wherein the spring is configured to disengage the catch from the first bearing when a second force is applied to the brake pedal in the first engaged configuration.

25. (canceled)

26. The brake assembly of claim 21, wherein when a second force is applied to the brake pedal in the first engaged configuration and then released, the brake pedal is configured to return to the first disengaged configuration, and the lock pedal is configured to return to the second disengaged configuration.

27. The brake assembly of claim 26, wherein when a third force is applied to the lock pedal in the second engaged configuration and then released, the brake pedal is configured to remain in the first engaged configuration, and the lock pedal is configured to remain in the second engaged configuration.
